(19) United States
(12) Patent Application Publication
(10) Pub. No.: US 2025/0015364 A1
(43) Pub. Date: Jan. 9, 2025

(54) SODIUM/LITHIUM PHOSPHOROTHIOATES AS NOVEL SOLID-STATE ELECTROLYTE FOR SODIUM/LITHIUM BATTERY

(71) Applicant: Trustees of Dartmouth College, Hanover, NH (US)

(72) Inventors: Chuanlong Wang, Troy, MI (US); Yiwen Zhang, Shanghai (CN); Weiyang Li, Bow, NH (US)

(73) Assignee: Trustees of Dartmouth College, Hanover, NH (US)

(21) Appl. No.: 18/709,497

(22) PCT Filed: Nov. 11, 2022
(86) PCT No.: PCT/US2022/049720

§ 371 Date: May 11, 2024

Related U.S. Application Data
(60) Provisional application No. 63/278,700, filed on Nov. 12, 2021.

(51) Int. Cl. H01M 10/39; C01B 25/14

(52) U.S. Cl. CPC H01M 10/3918; C01B 25/14; C01P 2002/72; C01P 2002/82; C01P 2002/85; C01P 2002/86; C01P 2002/88; C01P 2006/40; H01M 2300/0048

(57) ABSTRACT

The disclosure relates to solid-phase and molten metal phosphorothioates useful as electrolytes, batteries comprising solid-phase and molten metal phosphorothioates, and methods of making solid-phase and molten metal phosphorothioates.

### CROSS REFERENCE TO RELATED APPLICATIONS

This application claims priority to U.S. Patent Application Ser. No. 63/278,700, entitled “Sodium/Lithium Phosphorothioates as Novel Solid-State Electrolyte for Sodium/Lithium Battery”, filed Nov. 12, 2021, which is incorporated herein by reference.

### BACKGROUND

Traditional syntheses of solid-state ceramic electrolytes generally require high energy and high temperature. For sulfide solid electrolytes, which possess superior ionic conductivity, a high-energy ball milling process over 8˜50 hours and calcination at >500° C. are necessary for solid-state synthesis; sintering at 300° C. is needed for liquid-state synthesis. Accordingly, there is a need for cost-effective, energy-effective methods for preparing these materials.

### SUMMARY

The present disclosure provides, inter alia, a solid-phase or molten electrolyte comprising an mP₂S₅-nNa₂Sₓ complex, wherein the molar ratio of P₂S₅ to Na₂Sₓ (m:n) is between 1:2 and 2:1, and x is an integer from 1 to 12.

The present disclosure also provides solid-state battery comprising a cathode, an anode, and a solid-state electrolyte in contact with the cathode and the anode, wherein the cathode and/or the anode comprise an active material, a conductive additive, and a solid-state qP₂S₅-rM₂Sₓ complex; wherein M is Li or Na; the molar ratio of P₂S₅ to M₂Sₓ (q:r) is between 1:2 and 2:1; and wherein x is an integer from 1 to 12; wherein the solid-state electrolyte comprises a solid-phase mP₂S₅-nNa₂Sₓ complex; wherein the molar ratio of P₂S₅ to Na₂Sₓ (m:n) is between 1:2 and 2:1; and wherein x is an integer from 1 to 12.

The present disclosure further provides a method of manufacturing a solid-phase electrolyte comprising an mP₂S₅-nNa₂Sₓ complex, wherein the method comprises: (1) mixing sodium sulfide (Na₂S), phosphorus pentasulfide (P₂S₅), and sulfur powder (S) in an organic solvent to form a solvated mP₂S₅-nNa₂Sₓ complex; and (2) exposing the solvated mP₂S₅-nNa₂Sₓ complex to less-than-atmospheric pressure to precipitate a solid-phase mP₂S₅-nNa₂Sₓ complex wherein: the molar ratio of P₂S₅ to Na₂Sₓ (m:n) is between 1:2 and 2:1; and x is an integer from 1 to 12.

The present disclosure still further provides a method of manufacturing a molten electrolyte comprising an mP₂S₅-nNa₂Sₓ complex, wherein the method comprises: (1) manufacturing a solid-phase electrolyte comprising an mP₂S₅-nNa₂Sₓ complex according to a method of the present disclosure; and (2) heating the solid-phase electrolyte to form the molten electrolyte wherein: the molar ratio of P₂S₅ to Na₂Sₓ (m:n) is between 1:2 and 2:1; and x is an integer from 1 to 12.

### BRIEF DESCRIPTION OF THE DRAWINGS

FIG. 1 is a schematic of the complexation and precipitation process to produce mP₂S₅-nNa₂Sₓ solids.

FIG. 2 is a set of photos of P₂S₅—Na₂S and P₂S₅—Na₂S₈ in diglyme.

FIG. 3 is a set of photos of mP₂S₅-nNa₂S₈ (m:n=4:5, 2:3, 4:7 and 1:2) in diglyme.

FIG. 4 is a set of Raman profiles of P₂S₅—Na₂Sₓ (x=1, 6, 8) and mP₂S₅-nNa₂S₈ (m:n=4:5, 2:3, 4:7, 1:2) in diglyme.

FIG. 5 is a photo of P₂S₅—Na₂S₈ in 0.5 M, 1.0 M and 1.5 M concentrations in diglyme.

FIG. 6 is a set of Raman profiles of P₂S₅—Na₂S₈ in diglyme at different concentrations (0.5, 1.0 and 1.5M correspond to 28, 55, 83 wt % solid-to-liquid ratios, respectively).

FIG. 7 is a set of Raman profiles of P₂S₅—Na₂S₈ solids produced using different solvents.

FIG. 8A is a Raman profile of P₂S₅—Na₂S₈ solids.

FIG. 8B is an X-ray diffraction profile of P₂S₅—Na₂S₈ solids.

FIG. 8C is a Raman profile of P₂S₅—Na₂S solids.

FIG. 8D is an X-ray diffraction profile of P₂S₅—Na₂S solids.

FIG. 9 is a set of X-ray photoelectron spectroscopy profiles of P₂S₅—Na₂S₈, P₂S₅—Na₂S₆ and P₂S₅—Na₂S solids.

FIG. 10 is a graph depicting ³¹P solid-state nuclear magnetic resonance of P₂S₅—Na₂S₈ and P₂S₅—Na₂S solids.

FIG. 11A is a differential scanning calorimetry (DSC) curve of P₂S₅—Na₂S₈ solid.

FIG. 11B is an enlarged DSC curve of P₂S₅—Na₂S₈ solid.

FIG. 12A is a DSC curve of P₂S₅—Na₂S solid.

FIG. 12B is an enlarged DSC curve of P₂S₅—Na₂S solid.

FIG. 13 is a Ramen profile of melt phase (i.e., molten) P₂S₅—Na₂S₈.

FIG. 14 is a depiction of the proposed molecular structure of P₂S₅—Na₂S₈ solid/melt.

FIG. 15A is a schematic configuration of split cells for electrochemical impedance spectroscopy measurement.

FIG. 15B is a real set-up of split cells for electrochemical impedance spectroscopy measurement.

FIG. 16 is a set of electrochemical impedance spectroscopy curves of P₂S₅—Na₂S₈, P₂S₅—Na₂S₆ and 4P₂S₅-5Na₂S₈ solids.

FIG. 17 is a cyclic voltammetry curve of P₂S₅—Na₂S₈ solid electrolyte.

FIG. 18 is a set of electrochemical impedance spectroscopy curves of P₂S₅—Na₂S₈ melt after cooling for 10 minutes and 2 hours. No solidification was observed after cooling at 20° C. overnight.

FIG. 19 is a comparison of electrode preparation for solid-state batteries using the traditional method and using proposed method with molten P₂S₅—Na₂S₈ in lieu of binder.

### DETAILED DESCRIPTION

Unless defined otherwise, all technical and scientific terms used herein generally have the same meaning as commonly understood by one of ordinary skill in the art. Generally, the nomenclature used herein and the laboratory procedures in cell culture, molecular genetics, organic chemistry, and peptide chemistry are those well-known and commonly employed in the art.

As used herein, the articles “a” and “an” refer to one or to more than one (i.e., to at least one) of the grammatical object of the article. By way of example, “an element” means one element or more than one element. Furthermore, use of the term “including” as well as other forms, such as “include,” “includes,” and “included,” is not limiting.

As used herein, the term “about” will be understood by persons of ordinary skill in the art and will vary to some extent on the context in which it is used. As used herein when referring to a measurable value such as an amount, a temporal duration, and the like, the term “about” is meant to encompass variations of 20% or 10%, including ±5%, ±1%, and ±0.1% from the specified value, as such variations are appropriate to perform the disclosed methods.

### Solid-Phase and Molten Electrolytes

In one aspect, the present disclosure provides a solid-phase or molten electrolyte comprising an mP₂S₅-nM₂Sₓ complex, wherein: M is Li or Na; the molar ratio of P₂S₅ to M₂Sₓ (m:n) is between 1:2 and 2:1; and x is an integer from 1 to 12.

In some embodiments, M is Li. In some embodiments, M is Na.

The molar ratio of P₂S₅ to M₂Sₓ (m:n) is between 1:2 and 2:1. Accordingly, by nonlimiting example, the molar ratio of P₂S₅ to M₂Sₓ (m:n) may be 1:2, 4:7, 2:3, 4:5, 1:1, 5:4, 3:2, 7:4, or 2:1. In some embodiments, the molar ratio of P₂S₅ to M₂Sₓ (m:n) is between 1:1.5 and 1.5:1. In some embodiments, the molar ratio of P₂S₅ to M₂Sₓ (m:n) is between 1:1.25 and 1.25:1. In some embodiments, the molar ratio of P₂S₅ to M₂Sₓ (m:n) is between 1:1.1 and 1.1:1. In some embodiments, the molar ratio of P₂S₅ to M₂Sₓ (m:n) is 1:1.

In some embodiments, x is 1, 2, 3, 4, 5, 6, 7, 8, 9, 10, 11, or 12. In some embodiments, x is an integer from 5 to 9. In some embodiments, x is an integer from 6 to 8. In some embodiments, x is 1. In some embodiments, x is 6. In some embodiments, x is 8.

In some embodiments, the electrolyte is a solid-phase electrolyte. In some embodiments, the solid-phase electrolyte has an amorphous structure. In some embodiments, the solid-phase electrolyte has a melting point (Tₘ) that is at least 100° C. higher, at least 110° C. higher, at least 120° C. higher, at least 130° C. higher, at least 140° C. higher, at least 150° C. higher, at least 160° C. higher, at least 170° C. higher, at least 180° C. higher, or at least 190° C. higher than the freezing point (T_{f}) of the molten form of the solid-phase electrolyte. In some embodiments, the solid-phase electrolyte has a melting point (Tₘ) that is at least 100° C. higher than the freezing point (T_{f}) of the molten form of the solid-phase electrolyte. In some embodiments, the solid-phase electrolyte has a melting point (Tₘ) that is at least 140° C. higher than the freezing point (T_{f}) of the molten form of the solid-phase electrolyte. In some embodiments, the solid-phase electrolyte has a melting point (Tₘ) that is at least 180° C. higher than the freezing point (T_{f}) of the molten form of the solid-phase electrolyte.

In some embodiment, the electrolyte is a molten electrolyte. In some embodiments, the molten electrolyte does not solidify at a temperature of 0° C., −10° C., −20° C., −30° C., −40° C., −50° C., −60° C., −70° C., −80° C., or −90° C. In some embodiments, the molten electrolyte does not solidify at a temperature of 0° C. In some embodiments, the molten electrolyte does not solidify at a temperature of −50° C. In some embodiments, the molten electrolyte does not solidify at a temperature of −90° C.

Sodium (Na), as used in the present disclosure, possesses certain chemical/physical properties similar to Li, but Na also has several advantages over Li. By way of example, Na's first ionization energy of 495.8 kJ mol⁻¹ is lower than that of Li (520.2 kJ mol⁻¹), leading to improved kinetics in chemical reactions. As an earth-abundant element, Na is over 1000 times more abundant than Li in the earth crust. The cost of Na raw materials (carbonate salt) is more than 100 times less expensive than that of Li.

Accordingly, in another aspect, the present disclosure provides a solid-phase or molten electrolyte comprising an mP₂S₅-nNa₂Sₓ complex, wherein: the molar ratio of P₂S₅ to Na₂Sₓ (m:n) is between 1:2 and 2:1; and x is an integer from 1 to 12.

The molar ratio of P₂S₅ to Na₂Sₓ (m:n) is between 1:2 and 2:1. Accordingly, by nonlimiting example, the molar ratio of P₂S₅ to Na₂Sₓ (m:n) may be 1:2, 4:7, 2:3, 4:5, 1:1, 5:4, 3:2, 7:4, or 2:1. In some embodiments, the molar ratio of P₂S₅ to Na₂Sₓ (m:n) is between 1:1.5 and 1.5:1. In some embodiments, the molar ratio of P₂S₅ to Na₂Sₓ (m:n) is between 1:1.25 and 1.25:1. In some embodiments, the molar ratio of P₂S₅ to Na₂Sₓ (m:n) is between 1:1.1 and 1.1:1. In some embodiments, the molar ratio of P₂S₅ to Na₂Sₓ (m:n) is 1:1.

In some embodiments, x is 1, 2, 3, 4, 5, 6, 7, 8, 9, 10, 11, or 12. In some embodiments, x is an integer from 5 to 9. In some embodiments, x is an integer from 6 to 8. In some embodiments, x is 1. In some embodiments, x is 6. In some embodiments, x is 8.

In some embodiments, the electrolyte is a solid-phase electrolyte. In some embodiments, the solid-phase electrolyte has an amorphous structure. In some embodiments, the solid-phase electrolyte has a melting point (Tₘ) that is at least 100° C. higher, at least 110° C. higher, at least 120° C. higher, at least 130° C. higher, at least 140° C. higher, at least 150° C. higher, at least 160° C. higher, at least 170° C. higher, at least 180° C. higher, or at least 190° C. higher than the freezing point (T_{f}) of the molten form of the solid-phase electrolyte. In some embodiments, the solid-phase electrolyte has a melting point (Tₘ) that is at least 100° C. higher than the freezing point (T_{f}) of the molten form of the solid-phase electrolyte. In some embodiments, the solid-phase electrolyte has a melting point (Tₘ) that is at least 140° C. higher than the freezing point (T_{f}) of the molten form of the solid-phase electrolyte. In some embodiments, the solid-phase electrolyte has a melting point (Tₘ) that is at least 180° C. higher than the freezing point (T_{f}) of the molten form of the solid-phase electrolyte.

In some embodiment, the electrolyte is a molten electrolyte. In some embodiments, the molten electrolyte does not solidify at a temperature of 0° C., −10° C., −20° C., −30° C., −40° C., −50° C., −60° C., −70° C., −80° C., or −90° C. In some embodiments, the molten electrolyte does not solidify at a temperature of 0° C. In some embodiments, the molten electrolyte does not solidify at a temperature of −50° C. In some embodiments, the molten electrolyte does not solidify at a temperature of −90° C.

### Solid-State Batteries

In another aspect the present disclosure provides a solid-state battery comprising a cathode, an anode, and a solid-state electrolyte in contact with the cathode and the anode, wherein the cathode and/or the anode comprise an active material, optionally a conductive additive, and a solid-state qP₂S₅-rM₂Sₓ complex; wherein M is Li or Na; the molar ratio of P₂S₅ to M₂Sₓ (q:r) is between 1:2 and 2:1; and wherein x is an integer from 1 to 12; wherein the solid-state electrolyte comprises a solid-phase mP₂S₅-nM₂Sₓ complex; wherein M is Li or Na; the molar ratio of P₂S₅ to Na₂Sₓ (m:n) is between 1:2 and 2:1; and wherein x is an integer from 1 to 12.

In general, the solid-state batteries of the disclosure include two electrodes (an anode and a cathode) and a solid-state electrolyte, which is sandwiched between the anode and cathode. The electrodes of the solid-state battery may contain conductive additives (electronic conductivity), binders, active materials, and a solid-state electrolyte (ionic conductivity).

In some embodiments, the solid-phase qP₂S₅-rM₂Sₓ complex is a solid-phase qP₂S₅-rNa₂Sₓ complex, wherein: the molar ratio of P₂S₅ to Na₂Sₓ (q:r) is between 1:2 and 2:1; and x is an integer from 1 to 12.

In some embodiments, the molar ratio of P₂S₅ to Na₂Sₓ (q:r) is between 1:1.5 and 1.5:1. In some embodiments, the molar ratio of P₂S₅ to Na₂Sₓ (q:r) is between 1:1.25 and 1.25:1. In some embodiments, the molar ratio of P₂S₅ to Na₂Sₓ (q:r) is between 1:1.1 and 1.1:1. In some embodiments, the molar ratio of P₂S₅ to Na₂Sₓ (q:r) is 1:1.

In some embodiments, x of the solid-phase qP₂S₅-rNa₂Sₓ complex is 1, 2, 3, 4, 5, 6, 7, 8, 9, 10, 11, or 12. In some embodiments, x of the solid-phase qP₂S₅-rNa₂Sₓ complex is an integer from 5 to 9. In some embodiments, x of the solid-phase qP₂S₅-rNa₂Sₓ complex is an integer from 6 to 8. In some embodiments, x of the solid-phase qP₂S₅-rNa₂Sₓ complex is 1. In some embodiments, x of the solid-phase qP₂S₅-rNa₂Sₓ complex is 6. In some embodiments, x of the solid-phase qP₂S₅-rNa₂Sₓ complex is 8.

In some embodiments, the solid-phase qP₂S₅-rNa₂Sₓ complex has an amorphous structure. In some embodiments, the solid-phase qP₂S₅-rNa₂Sₓ complex has a melting point (Tₘ) that is at least 100° C. higher, at least 110° C. higher, at least 120° C. higher, at least 130° C. higher, at least 140° C. higher, at least 150° C. higher, at least 160° C. higher, at least 170° C. higher, at least 180° C. higher, or at least 190° C. higher than the freezing point (T_{f}) of the molten form of the solid-phase qP₂S₅-rNa₂Sₓ complex. In some embodiments, the solid-phase qP₂S₅-rNa₂Sₓ complex has a melting point (Tₘ) that is at least 100° C. higher than the freezing point (T_{f}) of the molten form of the solid-phase qP₂S₅-rNa₂Sₓ complex. In some embodiments, the solid-phase qP₂S₅-rNa₂Sₓ complex has a melting point (Tₘ) that is at least 140° C. higher than the freezing point (T_{f}) of the molten form of the solid-phase qP₂S₅-rNa₂Sₓ complex. In some embodiments, the solid-phase qP₂S₅-rNa₂Sₓ complex has a melting point (Tₘ) that is at least 180° C. higher than the freezing point (T_{f}) of the molten form of the solid-phase qP₂S₅-rNa₂Sₓ complex.

In some embodiments, the cathode and/or the anode further comprise one or more conductive additives.

In some embodiments, the cathode and/or the anode further comprise one or more active materials. By nonlimiting example, active materials suitable for inclusion in the anode include TiO₂, Sn, Sb and P. By nonlimiting example, active materials suitable for inclusion in the cathode include Na₃V₂(PO₄)₃, NaₓCoO₂, LiCoO₂, NaₓMnO₂, LiMnO₂, LFMP (lithium-iron-manganese-phosphate) and NCMA (nickel, cobalt, manganese, aluminum).

In some embodiments, the cathode and/or the anode further comprise a molten aP₂S₅-bM₂S_{y} complex, wherein: M is Li or Na; the molar ratio of P₂S₅ to Na₂S_{y} (a:b) is between 1:2 and 2:1; and y is an integer from 1 to 12.

In some embodiments, the cathode and/or the anode further comprise a molten aP₂S₅-bNa₂S_{y} complex, wherein: the molar ratio of P₂S₅ to Na₂S_{y} (a:b) is between 1:2 and 2:1; and y is an integer from 1 to 12.

In some embodiments, the molar ratio of P₂S₅ to Na₂S_{y} (a:b) is between 1:1.5 and 1.5:1. In some embodiments, the molar ratio of P₂S₅ to Na₂S_{y} (a:b) is between 1:1.25 and 1.25:1. In some embodiments, the molar ratio of P₂S₅ to Na₂S_{y} (a:b) is between 1:1.1 and 1.1:1. In some embodiments, the molar ratio of P₂S₅ to Na₂S_{y} (a:b) is 1:1.

In some embodiments, y is 1, 2, 3, 4, 5, 6, 7, 8, 9, 10, 11, or 12. In some embodiments, y is an integer from 5 to 9. In some embodiments, y is an integer from 6 to 8. In some embodiments, y is 1. In some embodiments, y is 6. In some embodiments, y is 8.

In some embodiments, the molten aP₂S₅-bNa₂S_{y} complex does not solidify at a temperature of 0° C., −10° C., −20° C., −30° C., −40° C., −50° C., −60° C., −70° C., −80° C., or −90° C. In some embodiments, the molten aP₂S₅-bNa₂S_{y} complex does not solidify at a temperature of 0° C. In some embodiments, the molten aP₂S₅-bNa₂S_{y} complex does not solidify at a temperature of −50° C. In some embodiments, the molten aP₂S₅-bNa₂S_{y} complex does not solidify at a temperature of −90° C.

In some embodiments, the molar ratio of P₂S₅ to Na₂Sₓ (q:r) and the molar ratio of P₂S₅ to Na₂S_{y} (a:b) are the same. In some embodiments, the molar ratio of P₂S₅ to Na₂Sₓ (q:r) and the molar ratio of P₂S₅ to Na₂S_{y} (a:b) are the different.

In some embodiments, x and y are the same. In some embodiments, x and y are the different.

In some embodiments, the molar ratio of P₂S₅ to Na₂Sₓ (q:r) and the molar ratio of P₂S₅ to Na₂S_{y} (a:b) are the same, and x and y are the same.

In some embodiments, the molar ratio of P₂S₅ to Na₂Sₓ (q:r) and the molar ratio of P₂S₅ to Na₂S_{y} (a:b) are different, or x and y are different.

In some embodiments, the molar ratio of P₂S₅ to Na₂Sₓ (q:r) and the molar ratio of P₂S₅ to Na₂S_{y} (a:b) are different, and x and y are different.

In some embodiments, the cathode and/or the anode comprise a continuous interphase.

An electrode (i.e., a cathode or anode) having a “continuous interphase” is one that lacks significant voids between the component parts of the electrode. Traditionally prepared electrodes employ the use of binders to form a closely packed structure. Typical binders, however, are poorly conductive as compared to the solid-phase electrolyte and cannot completely fill the interstitial spaces between the other components of the electrodes. Thus, traditional electrodes contain voids within their structure and are characterized as having a “discontinuous interphase” (FIG. 19). By employing molten aP₂S₅-bM₂S_{y} complexes (which possess high conductivity and are fluid in nature) as ion conductive interphases in lieu of traditional binders, the electrodes of the present disclosure are able to overcome certain disadvantages of traditional electrodes.

### Fabrication of Solid-Phase and Molten Electrolytes

In contrast to traditional syntheses of solid sulfide electrolytes, which require high energy and temperature, the solid-phase and molten electrolytes of the present disclosure can be produced via a cost-effective, scalable process with low energy and temperature requirements. The process involves two main steps: complexation of precursors in a solvent, and solid precipitation of the complexes from the solution.

Accordingly, in an aspect, the present disclosure provides a method of manufacturing a solid-phase electrolyte comprising an mP₂S₅-nNa₂Sₓ complex, wherein the method comprises: mixing sodium sulfide (Na₂S), phosphorus pentasulfide (P₂S₅), and sulfur powder (S) in an organic solvent to form a solvated mP₂S₅-nNa₂Sₓ complex; and exposing the solvated mP₂S₅-nNa₂Sₓ complex to less-than-atmospheric pressure to precipitate a solid-phase mP₂S₅-nNa₂Sₓ complex; wherein the molar ratio of P₂S₅ to Na₂Sₓ (m:n) is between 1:2 and 2:1, and x is an integer from 1 to 12.

Organic solvents suitable for use in the methods of the disclosure will be identifiable by those skilled in the art. By non-limiting example, the organic solvent may be diethylene glycol dimethyl ether (diglyme), 1,2-dimethoxyethane, 1,3-dioxolane, tetrahydrofuran, tetraethylene glycol dimethyl ether, or methyl acetate. In some embodiments, the organic solvent is diglyme, 1,2-dimethoxyethane, 1,3-dioxolane, or methyl acetate. In some embodiments, the organic solvent is diglyme.

The concentration of the solvated mP₂S₅-nNa₂Sₓ complex in the organic solvent prior to precipitation may, by nonlimiting example, be between about 0.1 M and about 4 M. In some embodiments, the concentration of the solvated mP₂S₅-nNa₂Sₓ complex in the organic solvent prior to precipitation is between about 0.5 M and about 2 M. In some embodiments, the concentration of the solvated mP₂S₅-nNa₂Sₓ complex in the organic solvent prior to precipitation is between about 0.5 M and about 1.5 M. In some embodiments, the concentration of the solvated mP₂S₅-nNa₂Sₓ complex in the organic solvent prior to precipitation is about 0.5 M. In some embodiments, the concentration of the solvated mP₂S₅-nNa₂Sₓ complex in the organic solvent prior to precipitation is about 1 M. In some embodiments, the concentration of the solvated mP₂S₅-nNa₂Sₓ complex in the organic solvent prior to precipitation is about 1.5 M.

In some embodiments, the method further comprises transferring the solvated mP₂S₅-nNa₂Sₓ complex to a quartz crucible prior to exposing the complex to less-than-atmospheric pressure. In some embodiments, the method further comprises sealing the solvated mP₂S₅-nNa₂Sₓ complex in a vacuum tube under an inert gas prior to exposing the complex to less-than-atmospheric pressure. In some embodiments, the inert gas is argon.

In some embodiments, the less-than-atmospheric pressure is between about 0.001 MPa and about 0.25 MPa. In some embodiments, the less-than-atmospheric pressure is between about 0.025 MPa and about 0.1 MPa. In some embodiments, the less-than-atmospheric pressure is about 0.05 MPa.

In some embodiments, the solvated mP₂S₅-nNa₂Sₓ complex is heated while under less-than-atmospheric pressure. In some embodiments, the solvated mP₂S₅-nNa₂Sₓ complex is heated at a temperature between about 100° C. and about 200° C. while under less-than-atmospheric pressure. In some embodiments, the solvated mP₂S₅-nNa₂Sₓ complex is heated at a temperature of about 150° C. while under less-than-atmospheric pressure.

In some embodiments, the solvated mP₂S₅-nNa₂Sₓ complex is exposed to less-than-atmospheric pressure for at least 0.5 hours, at least 1 hour, at least 1.5 hours, at least 2 hours, at least 2.5 hours, at least 3 hours, at least 3.5 hours, at least 4 hours, at least 4.5 hours, or at least 5 hours. In some embodiments, the solvated mP₂S₅-nNa₂Sₓ complex is exposed to less-than-atmospheric pressure for between 2 hours and 4 hours. In some embodiments, the solvated mP₂S₅-nNa₂Sₓ complex is exposed to less-than-atmospheric pressure for about 3 hours.

In another aspect, the disclosure provides a method of manufacturing a molten electrolyte comprising an mP₂S₅-nNa₂Sₓ complex, wherein the method comprises manufacturing a solid-phase electrolyte comprising an mP₂S₅-nNa₂Sₓ complex according to the methods disclosed herein; and heating the solid-phase electrolyte to form the molten electrolyte; wherein the molar ratio of P₂S₅ to Na₂Sₓ (m:n) is between 1:2 and 2:1; and x is an integer from 1 to 12.

In some embodiments, the solid-phase electrolyte is heated at a temperature above 50° C. In some embodiments, the solid-phase electrolyte is heated at a temperature from about 50° C. to about 120° C. In some embodiments, the solid-phase electrolyte is heated at a temperature of about 60° C.

This disclosure is further illustrated by the following Items:

1. A solid-phase or molten electrolyte comprising an mP₂S₅-nNa₂Sₓ complex, wherein the molar ratio of P₂S₅ to Na₂Sₓ (m:n) is between 1:2 and 2:1 and x is an integer from 1 to 12.

2. The solid-phase or molten electrolyte of Item 1, wherein the molar ratio of P₂S₅ to Na₂Sₓ (m:n) is 1:1.

3. The solid-phase or molten electrode of any of preceding Items, wherein x is an integer from 6 to 8.

4. The solid-phase or molten electrode of any of preceding Items, wherein x is 8.

5. A solid-state battery comprising a cathode, an anode, and a solid-state electrolyte in contact with the cathode and the anode, wherein the cathode and/or anode comprise:
an active material;
optionally a conductive additive; and
a solid-state qP₂S₅-rNa₂Sₓ complex, wherein:
   the molar ratio of P₂S₅ to Na₂Sₓ (q:r) is between 1:2 and 2:1; and
   x is an integer from 1 to 12;
      and wherein the solid-state electrolyte comprises a solid-phase mP₂S₅-nNa₂Sₓ complex, wherein the molar ratio of P₂S₅ to Na₂Sₓ (m:n) is between 1:2 and 2:1 and wherein x is an integer from 1 to 12.

6. The solid-state battery of Item 5, wherein the molar ratio of P₂S₅ to Na₂Sₓ (q:r) is 1:1.

7. The solid-state battery of any of Items 5-6, wherein x of the solid-state qP₂S₅-rNa₂Sₓ complex is 8.

8. The solid-state battery of Item 5, wherein the cathode and/or anode further comprise a molten aP₂S₅-bNa₂S_{y} complex, wherein the molar ratio of P₂S₅ to Na₂S_{y} (a:b) is between 1:2 and 2:1; and y is an integer from 1 to 12.

9. The solid-state battery of Item 8, wherein the molar ratio of P₂S₅ to Na₂S_{y} (a:b) is 1:1.

10. The solid-state battery of any of Items 8-9, wherein y is 8.

11. The solid-state battery of any of Items 8-10, wherein the molar ratio of P₂S₅ to Na₂Sₓ (q:r) and the molar ratio of P₂S₅ to Na₂S_{y} (a:b) are the same and x and y are the same.

12. The solid-state battery of any of Items 8-10, wherein the molar ratio of P₂S₅ to Na₂Sₓ (q:r) and the molar ratio of P₂S₅ to Na₂S_{y} (a:b) are different or x and y are different.

13. The solid-state battery of any of Items 8-12, wherein the cathode and/or the anode comprise a continuous interphase.

14. A method of manufacturing a solid-phase electrolyte comprising an mP₂S₅-nNa₂Sₓ complex, wherein the method comprises:
mixing sodium sulfide (Na₂S), phosphorus pentasulfide (P₂S₅), and sulfur powder (S) in an organic solvent to form a solvated mP₂S₅-nNa₂Sₓ complex; and
exposing the solvated mP₂S₅-nNa₂Sₓ complex to less-than-atmospheric pressure to precipitate a solid-phase mP₂S₅-nNa₂Sₓ complex;
wherein the molar ratio of P₂S₅ to Na₂Sₓ (m:n) is between 1:2 and 2:1 and x is an integer from 1 to 12.

15. The method of Item 14, wherein organic solvent is selected from the group consisting of diethylene glycol dimethyl ether (diglyme), 1,2-dimethoxyethane, 1,3-dioxolane, tetrahydrofuran, tetraethylene glycol dimethyl ether, and methyl acetate.

16. The method of Item 14, wherein organic solvent is diglyme.

17. The method of any of Items 14-16, wherein the concentration of solvated mP₂S₅-nNa₂Sₓ complex in the organic solvent prior to precipitation is between about 0.5 M and about 2 M.

18. The method of Items 14-17, wherein the concentration of solvated mP₂S₅-nNa₂Sₓ complex in the organic solvent prior to precipitation is about 1.5 M.

19. A method of manufacturing a molten electrolyte comprising an mP₂S₅-nNa₂Sₓ complex, wherein the method comprises:
manufacturing a solid-phase electrolyte comprising an mP₂S₅-nNa₂Sₓ complex according to the method of claim 12; and
heating the solid-phase electrolyte to form the molten electrolyte;
wherein the molar ratio of P₂S₅ to Na₂Sₓ (m:n) is between 1:2 and 2:1 and x is an integer from 1 to 12.

20. The method of Item 19, wherein the solid-phase electrolyte is heated at a temperature of from about 50° C. to about 120° C.

### EXAMPLES

### Example 1: Preparation and Characterization of Sodium Phosphorothioates

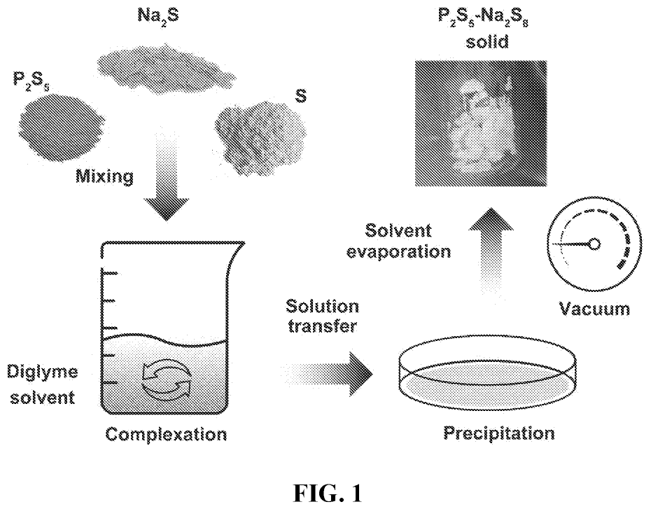

Fabrication of mP₂S₅-nNa₂Sₓ solids via complexation and precipitation mP₂S₅-nNa₂Sₓ solids were produced via two main steps: complexation and precipitation (FIG. 1). During the complexation step, commercial sodium sulfide (Na₂S), phosphorus pentasulfide (P₂S₅) and sulfur (S) powders were used as precursors for the synthesis of mP₂S₅-nNa₂Sₓ (1≤x≤8, molar ratio of P₂S₅ to Na₂Sₓ is m:n) in a solvent (e.g., diglyme). The mixture was stirred in an argon (Ar)-purged glove box at room temperature to form a solution up to a solid-to-liquid ratio of 83 wt %. During the precipitation process, the complexed solutions were then transferred to a high vacuum desiccator that is capable of pumping down to vacuum level of 0.1 bar through an external pump. The precipitation step was then proceeded under the vacuum with or without heating, where a yellow solid (e.g. P₂S₅—Na₂S₈) could be obtained after the full evaporation of solvent.

### Characterization Protocols

Laser Raman spectroscopy (LRS) used a Horiba labRAM HR Evolution operating at 532 nm wavelength with a double pass macro cuvette holder. Raman shifts were calibrated using the sharp characterization peak at 520 cm⁻¹ of the standard silicon sample. X-ray diffraction (XRD) was carried out using Rigaku (model no. 007) with a scanning angle 20 from 10° to 70°. X-ray photoelectron spectroscopy (XPS) was conducted on a PHI Versaprobe II scanning XPS microprobe with a 0.47 eV system resolution using a monochromatic 1486.7 X-ray source. The samples were transferred into the XPS chamber via an Argon-filled, sealed vessel to avoid exposure to air. Differential scanning calorimetry (DSC) was performed using Netzsch DSC 204 F1 Phoenix. The temperature range of P₂S₅—Na₂S is −90° C. to 600° C. and the one of P₂S₅—Na₂S₈ is −90° C. to 170° C. Both samples and reference were tested at a controlled rate of 10° C./min. ³¹P solid-state nuclear magnetic resonance (ssNMR) was performed using a Bruker AVIII 500 MHz with a 4.0 mm HX probe.

Characterization of Sodium Phosphorothioates after Complexation

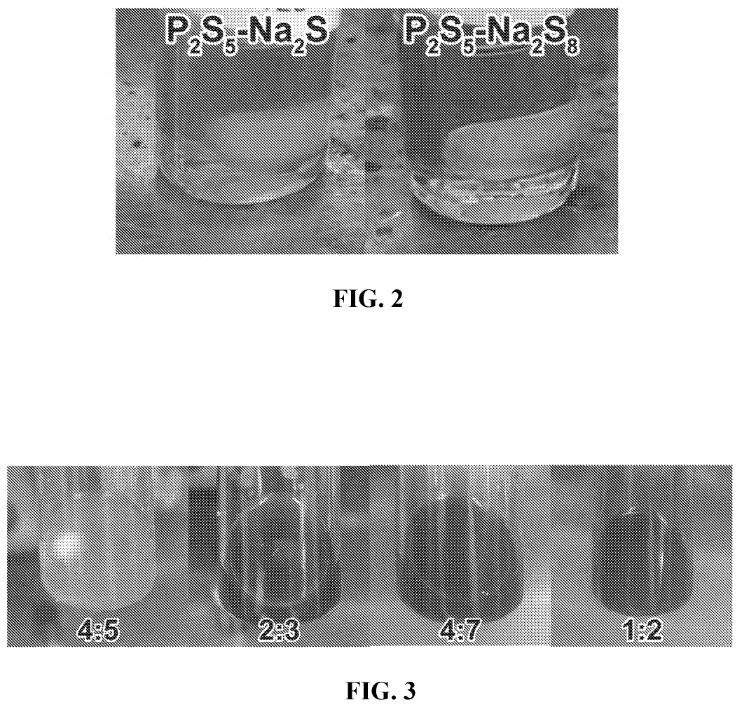

The mP₂S₅-nNa₂Sₓ family of materials can be tailored in two dimensions: the Sₓ chain length (x) and the P₂S₅-to-Na₂Sₓ molar ratio (m:n). It was observed that both Sₓ chain length and m:n molar ratio affect the nature and color of the prepared systems (FIG. 2 and FIG. 3).

Specifically, P₂S₅—Na₂S solution exhibits an orange color while the P₂S₅—Na₂S₈ exhibits a yellow color. Unlike the transparency observed in two 1:1 systems, mP₂S₅-nNa₂S₈ (m:n=4:5, 2:3, 4:7 and 1:2) exhibits opacity to some extent, the colors of which become darker with the increase of Na₂S₈ (i.e., the decrease of m:n).

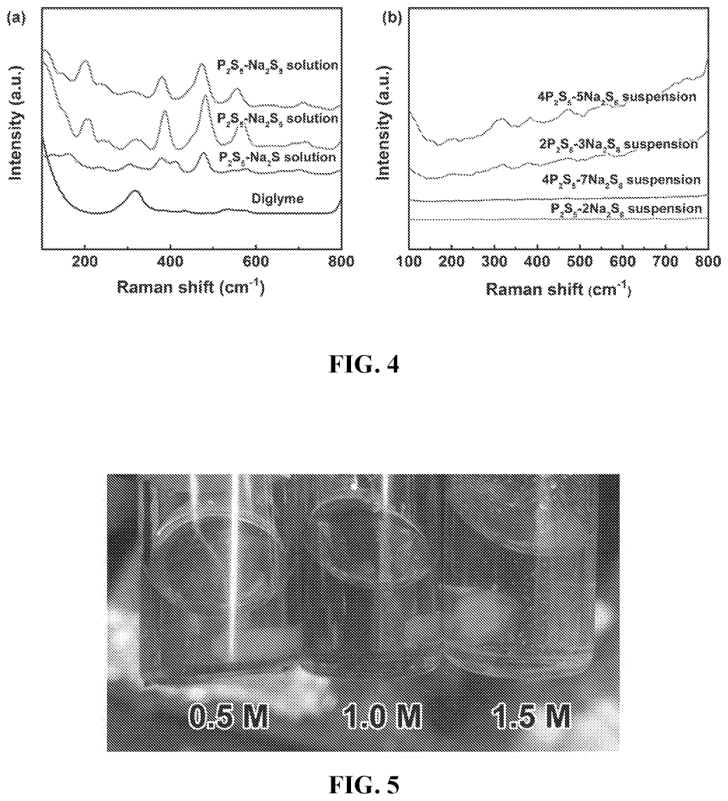

Raman spectroscopy was employed to identify the synthesized complexes and study the chemical bonding. As shown in FIG. 4, the Raman profile of P₂S₅—Na₂S shows distinctive and similar peak positions to those in P₂S₅—Na₂Sₓ (x=6, 8), where the peaks at 388 and 418 cm⁻¹ indicate the presence of P^{2″} while the peak at 482 cm⁻¹ is ascribed to the symmetric stretching modes of —S—S—. The increase of the variable x leads to lower-energy shift of the —S—S— mode. In P₂S₅—Na₂Sₓ (x=6, 8) profiles, the band at 200˜215 cm⁻¹ suggests the presence of P²/P³ SROs while peaks at 386 and 493 cm⁻¹ reveal the modes in P² SRO. The peak at 575 cm⁻¹ is assigned to T₂ asymmetric stretching of tetrahedral structure.

Regarding the P₂S₅-to-Na₂Sₓ molar ratio (m:n), it was observed that the peak intensities become weaker with a higher content of Na₂S₈ (FIG. 4), possibly owing to the strong light absorption of the excess Na₂S₈.

### Optimization and Investigation of Precipitation Step

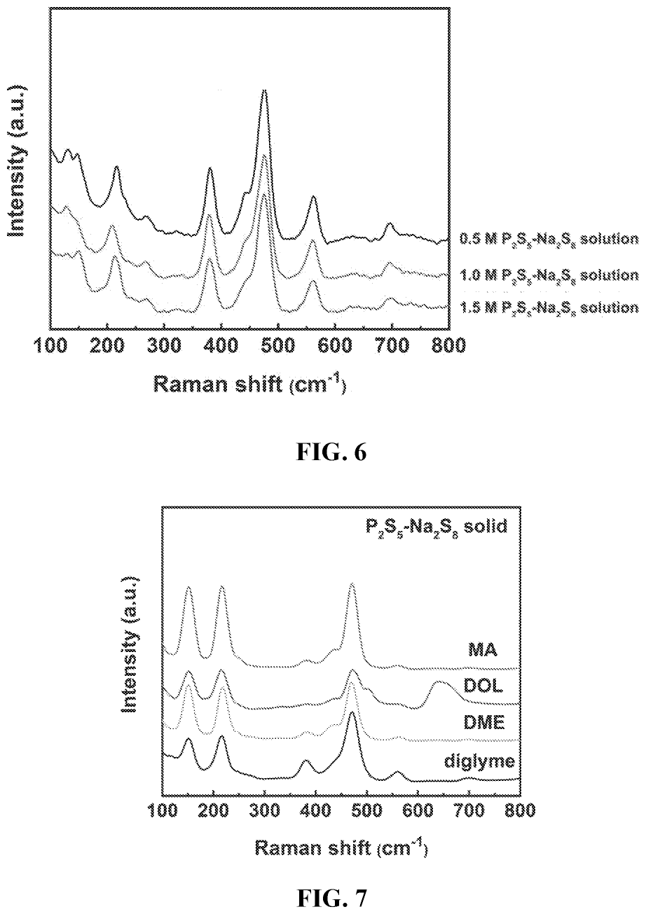

It was determined that both solute concentration and solvent type affected the yield for the precipitation process and the efficiency of the complexation-precipitation approach. In diglyme, the concentration of P₂S₅—Na₂S₈ could be prepared up to 1.5 M (83 wt % solid-to-liquid ratio), without exhibiting any obvious differences in appearance (FIG. 5) or molecular structure (FIG. 6) compared to those in 0.5 M (28 wt %) and 1.0 M (55 wt %). However, the preparation of concentrated P₂S₅—Na₂S₈ in diglyme (1.5 M) required the assistance of heating (60° C.).

Besides diglyme, three other solvents—1,2-dimethoxyethane (DME), 1,3-dioxolane (DOL) and methyl acetate (MA)—were investigated with respect to the stability of the P₂S₅—Na₂S₈ complex (FIG. 7). The precipitates from the four systems show similar Raman profiles (the solid from DOL shows an additional peak at 600˜700 cm⁻¹), indicating the P₂S₅—Na₂S₈ complex is compatible with an array of solvents. Of the tested solvents, diglyme shows the highest solubility of P₂S₅—Na₂S₈, confirming the practicality of the solvent to achieve high yield in the process.

A concentration of 1.5 M (83 wt %) in diglyme solvent was employed to produce the solid phase of P₂S₅—Na₂S₈ for further characterization and electrochemical evaluation.

Characterization of the Structure and Composition of Solid P₂S₅—Na₂S₈

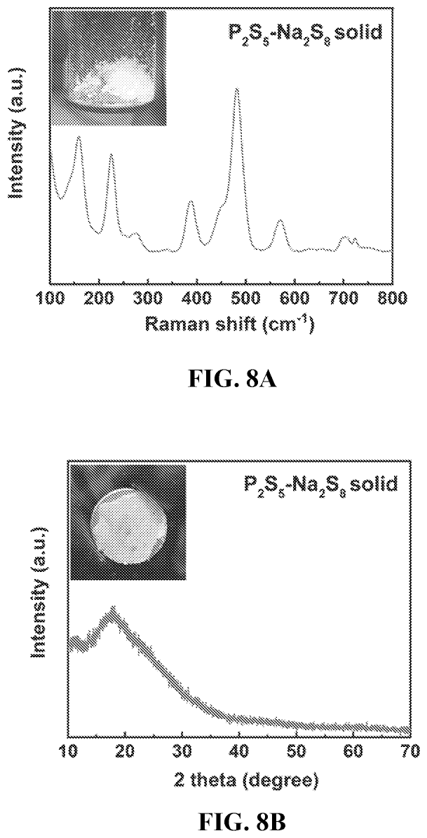

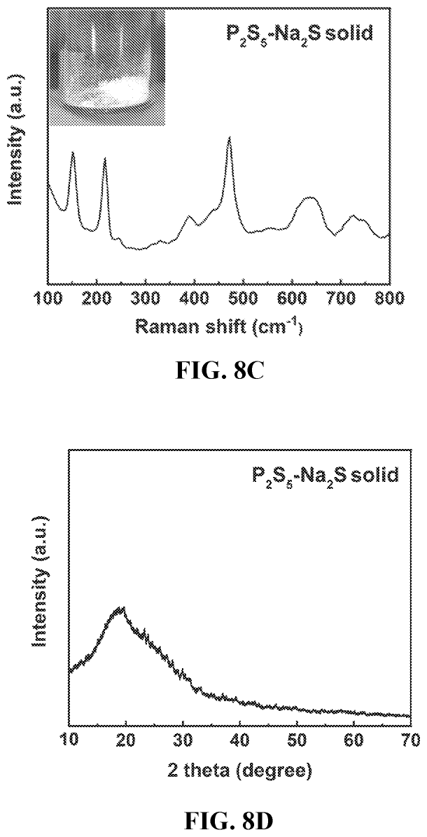

To investigate the nature of solid P₂S₅—Na₂S₈, both Raman spectroscopy and X-ray powder diffraction (XRD) were conducted using P₂S₅—Na₂S as a control. Almost no additional peak occurrence/disappearance can be observed in P₂S₅—Na₂S₈ solid (FIG. 8A) as compared to the solvated complex, indicating the solid sample possesses similar composition and network structure as those in the corresponding solution sample (in diglyme). (Notably, the diglyme solvent peak (˜317 cm⁻¹) disappears in the solid phase spectrum). In contrast, solid P₂S₅—Na₂S (FIG. 8C) had a distinct profile from the corresponding solvated complex, suggesting a change in composition and/or structure following evaporation of the solvent. Both solids reveal amorphous phases as characterized in XRD (FIGS. 8B and 8D).

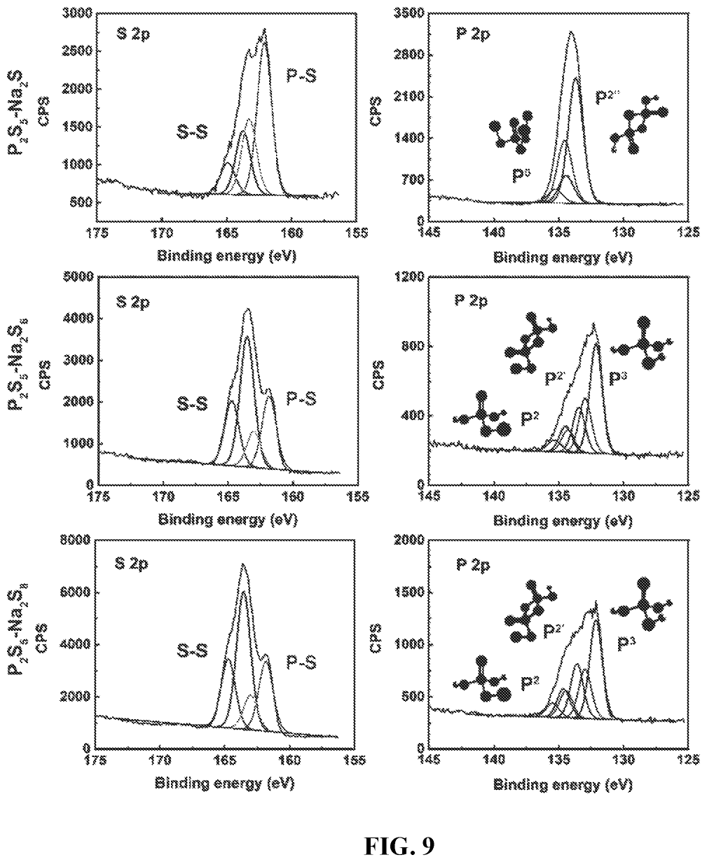

X-ray photoelectron spectroscopy (XPS) and ³¹P solid-state nuclear magnetic resonance (ssNMR) were performed to further characterize the molecular structure of the solid P₂S₅—Na₂S₈ complex. For XPS, the binding energies of all elements were calibrated with respect to C₁ₛ at 284.8 eV (FIG. 9). For the peak-fitting of S₂ₚ, the 2p_{3/2} to 2p_{1/2} area ratio is fixed at 2:1 according to the ratio of degeneracy, where 1.18 eV is employed as the doublet separation of 2p_{3/2} and 2p_{1/2}. As to the peak-fitting of P₂ₚ, the 2p_{3/2} to 2p_{1/2} area ratio is fixed at 2:1 according to the ratio of degeneracy, where 0.87 eV is used as the doublet separation of 2p_{3/2} and 2p_{1/2}. Studies regarding the solvated complex have revealed that long chain P₂S₅—Na₂Sₓ (x=6, 8) possesses three main Pⁿ SROs, including P³, P² and P^{2′}, while short chain P₂S₅—Na₂S has P^{2″} and P⁰ SROs. Therefore, the peaks at −132.13, 133.50 and 134.63 eV (based on 2p_{3/2}) in P₂ₚ can be assigned to P³, P^{2′} and P² in P₂S₅—Na₂Sₓ (x=6, 8), respectively, while the ones at −133.70 and 134.42 eV can be ascribed to P^{2″} and P⁰ in P₂S₅—Na₂S, respectively. As to S₂ₚ, the peaks at 162.10 and 163.75 eV are attributed to the presence of P—S and S—S, respectively. It was observed that samples with longer Sₓ chain (x=6, 8) showed higher concentration of S—S(bridging S in Sₓ) over P—S, compared to the short chain sample (P₂S₅—Na₂S).

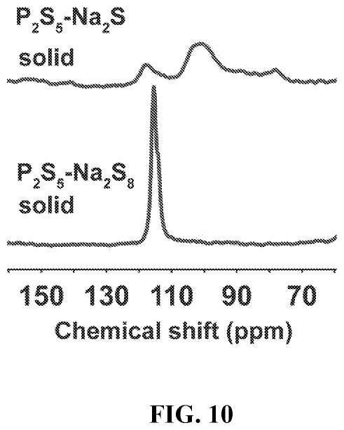

The main narrow peak in the ssNMR spectrum of P₂S₅—Na₂S₈ solid can be fitted with three peaks at 116.3, 115.5 and 114 ppm, representing the existence of P³, P² and P^{2′} (FIG. 10). In contrast, two different P sites of 118 ppm and 101.8 ppm in solid P₂S₅—Na₂S can be assigned to the presence of P^{2″} and P⁰. The weak spinning sidebands are due to chemical shift anisotropy (CSA).

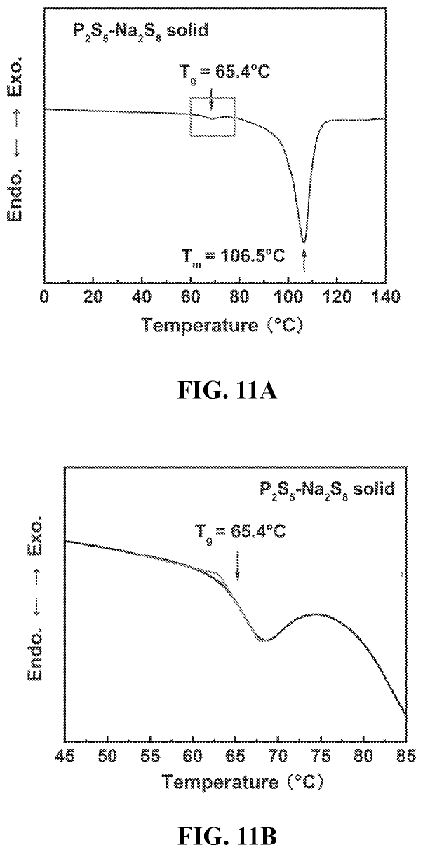

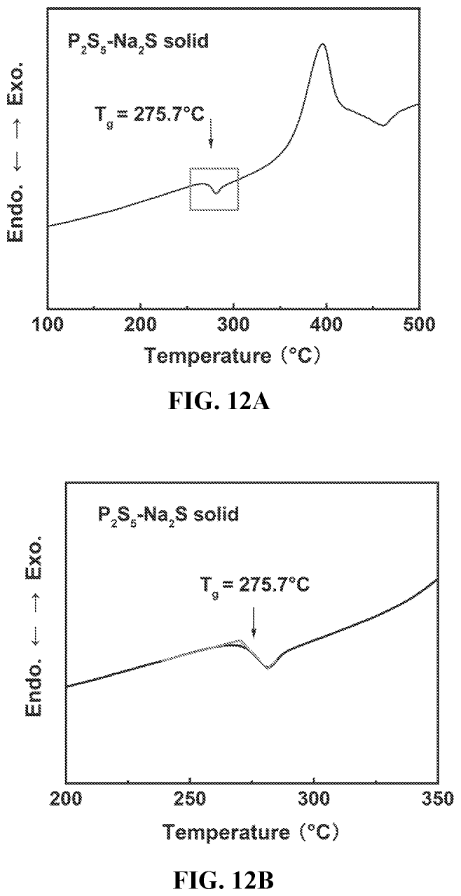

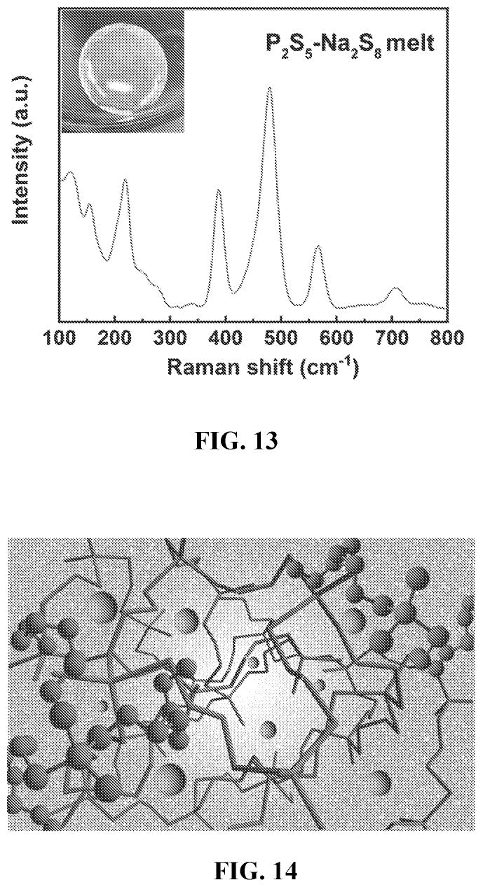

Differential scanning calorimetry (DSC) was carried out to investigate thermal behaviors of P₂S₅—Na₂S₈ and P₂S₅—Na₂S solids (FIGS. 11A, 11B, 12A, and 12B). In particular, P₂S₅—Na₂S solid exhibited a glass transition point (T_{g}) at 275.7° C. and an exothermic reaction at 400° C. The exothermic reaction is likely related to the crystallization process of the Na₃PS₄ phase. In contrast, P₂S₅—Na₂S₈ solid showed a T_{g} at 65.4° C. along with a melting point (Tₘ) of 106.5° C. Surprisingly, it was observed that molten P₂S₅—Na₂S₈ (denoted P₂S₅—Na₂S₈ melt) did not solidify even after the temperature was lowered to −90° C. This observation confirms the irreversibility of Tₘ in P₂S₅—Na₂S₈. As shown in FIG. 13, the P₂S₅—Na₂S₈ melt shows the same molecular structure as that of the corresponding solid.

### Example 2: Ionic Conductivity and Electrochemical Stability of P₂S₅—Na₂S₈ Solid

Based on the characterization data of Example 1, a molecular structure of a highly interconnected network has been proposed for P₂S₅—Na₂S₈ solid/melt, which contains an open framework likely facilitating the diffusion of Na⁺ ions (FIG. 14).

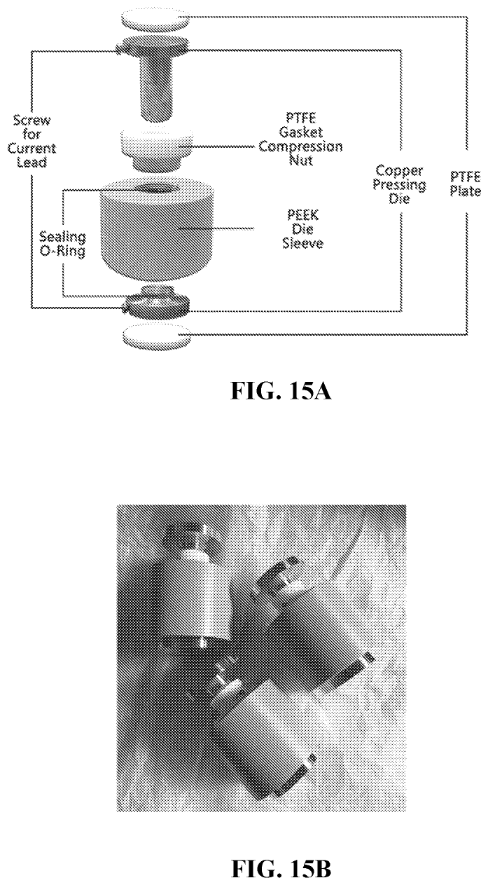

To prepare the solid-state electrolyte for electrochemical evaluation, thin pellets were fabricated through cold-pressing process. The as-synthesized solid materials were accommodated in a dry pellet pressing die and further pressed through a cold isostatic press. The obtained pellets were then subjected to electrochemical impedance spectroscopy (EIS) measurement via split cells as depicted in FIGS. 15A and 15B.

The split cells loaded with the pellet sandwiches were pressed via the isostatic press to ensure a good contact. Electrochemical impedance spectroscopy (EIS) was conducted using an electrochemical workstation (VMP3, Bio-Logic Science Instruments) at a scanning frequency from 1 MHz to 0.1 Hz with an AC amplitude of 5 mV.

The ionic conductivity was calculated by analyzing the obtained Nyquist plot. The plot was fitted to an equivalent circuit in the form of (R_{bulk})(R_{gb}Q_{gb})(Q_{electrode}), where R_{bulk} is bulk resistance, R_{gb} is grain boundary resistance, Q_{gb} is grain boundary capacitance, and Q_{electrode} is double layer capacitance from the ion blocking electrodes. The bulk resistance was attributed to the end point of the semi-circle at the high-frequency zone. With the obtained bulk resistance, the ionic conductivity (δ) could then be calculated using the equation of [δ=d/(R_{bulk}×A)], where d is the pellet thickness, and A is the pellet area contacting the copper pressing die. The calculated δ will be recorded in millisiemens per centimeter (mS/cm).

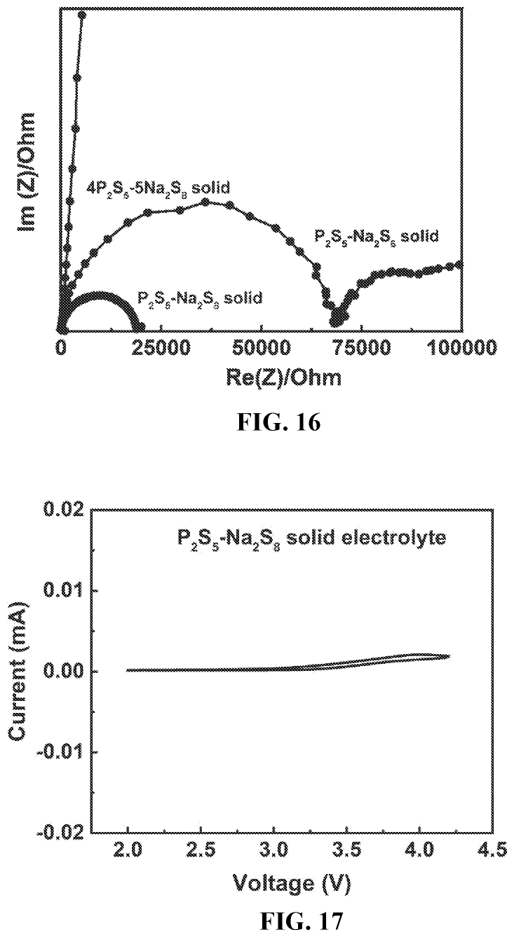

The Nyquist plot of P₂S₅—Na₂S₈ solid was compared with the ones of P₂S₅—Na₂S₆ solid and 4P₂S₅-5Na₂S₈ solid (FIG. 16). P₂S₅—Na₂S₈ solid showed the smallest bulk resistance. After calculation, P₂S₅—Na₂S₈ was determined to possess the ionic conductivity of 4.86×10\hat{ }(−2) mS cm⁻¹ (Table 1), which is two orders of magnitude larger than that of P₂S₅—Na₂S₆ and three orders of magnitude larger than that of P₂S₅-3Na₂S (P₂S₅—Na₂S shows no conductivity). As for the m:n ratio, 4P₂S₅-5Na₂S₈ showed a much smaller value of 5.87×10\hat{ }(−5) mS cm⁻¹ while 2P₂S₅-3Na₂S₈ was out of range. Surprisingly, the increase of Na₂S₈ does not improve the ionic conductivity of mP₂S₅-nNa₂S₈ even though the concentration of Na⁺ ions is enhanced in the bulk. Therefore, the maintenance of a highly interconnected network as depicted in FIG. 14 appears to be more critical in producing high conductivity.

The electrochemical stability of electrolytes is a key parameter affecting their utility and application. As shown in FIG. 17, the obtained P₂S₅—Na₂S₈ solid electrolyte showed a stability window of 2.0 V to 4.2 V when sandwiched within two identical stainless steel current collectors.

TABLE 1
Summary of ionic conductivity results of mP₂S₅—nNa₂Sₓ solids.

| | | Conductivity | Conductivity |
|---|---|---|---|
| | | (mS cm⁻¹) | (mS cm⁻¹) |
| | Sample | without calibration | after calibration |
| —Sₓ— chain | P₂S₅—Na₂S | N/A | N/A |
| effect | P₂S₅—Na₂S₆ | 5.60 × 10\hat{ }(−4) | 8.96 × 10\hat{ }(−4) |
| | P₂S₅—Na₂S₈ | 3.04 × 10\hat{ }(−2) | 4.86 × 10\hat{ }(−2) |
| Ratio effect | 4P₂S₅—5Na₂S₈ | 3.67 × 10\hat{ }(−5) | 5.87 × 10\hat{ }(−5) |
| | 2P₂S₅—3Na₂S₈ | Out of range | Out of range |

Note:
Commercial NASICON was used to calibrate the measured conductivity results (Measured value: 0.75 mS cm⁻¹; Reported value (from the company): 1.2 mS cm⁻¹).
P₂S₅—3Na₂S (stands for 2Na₃PS₄) shows 4.2 × 10\hat{ }(−5) mS cm⁻¹ without calibration.
“N/A” indicates that the electrolyte system is not stable during EIS measurement.

### Example 3: Novel Electrode Preparation for Solid-State Batteries Using P₂S₅—Na₂S₈ Melt

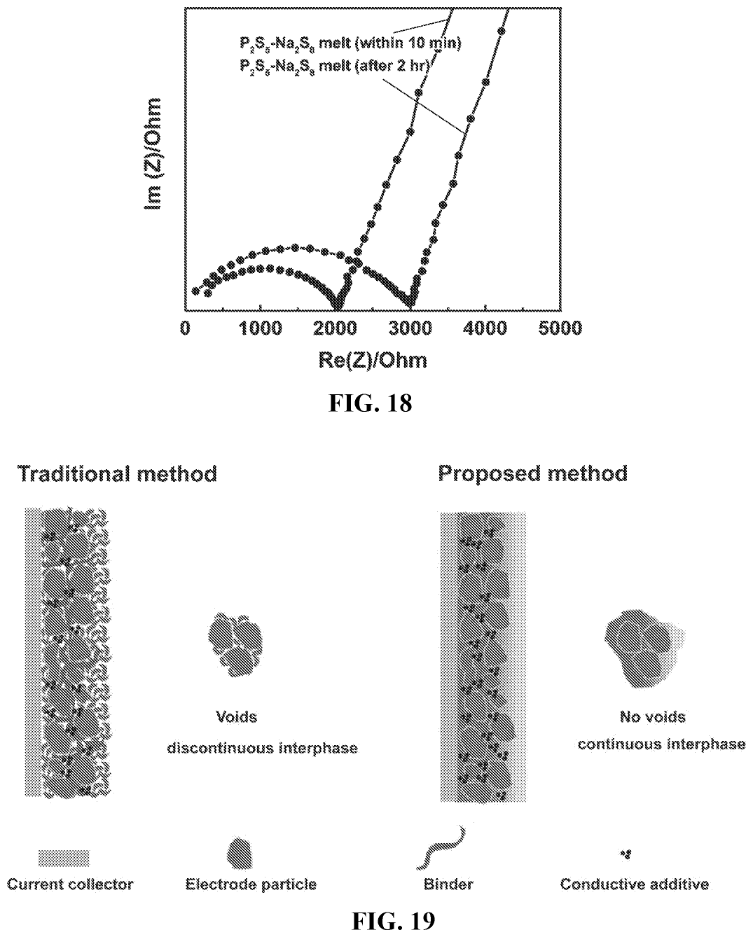

The ionic conductivity and resistance of P₂S₅—Na₂S₈ melt were also evaluated. The resistance of P₂S₅—Na₂S₈ melt did not increase much even after cooling at −35° C. for 2 hours (FIG. 18). After calculation, the ionic conductivity of P₂S₅—Na₂S₈ melt was found to be 9.12×10\hat{ }(−3) mS cm⁻¹, only 5 times smaller than that of P₂S₅—Na₂S₈ solid (Table 2).

Traditional preparation of the electrodes for solid-state batteries is a time-consuming process involves the mixing of solid electrolyte, conductive additive, binder, and active electrode materials. Furthermore, the production of voids and the formation of discontinuous interphase are issues that arise using the traditional method (FIG. 19). Consequently, the reaction kinetics and the full cell performance of traditionally prepared solid-state batteries are largely impeding.

A new approach for preparing the electrodes for solid-state batteries takes advantage of the ion-conducting property and fluidity of P₂S₅—Na₂S₈ melt. Specifically, P₂S₅—Na₂S₈ melt can not only provide an ionic path but also serve as binder. Therefore, the energy density and reaction kinetics of the solid-state battery can be dramatically improved by avoiding the need for heavy binder materials and by filling the voids and generating continuous interphase (FIG. 19).

TABLE 2
Comparison of ionic conductivity results
of P₂S₅—Na₂S₈ solid and melt.

| | Conductivity (mS cm⁻¹) | Conductivity (mS cm⁻¹) |
|---|---|---|
| Sample | without calibration | after calibration |
| P₂S₅—Na₂S₈ solid | 3.04 × 10\hat{ }(−2) | 4.86 × 10\hat{ }(−2) |
| P₂S₅—Na₂S₈ melt | 5.70 × 10\hat{ }(−3) | 9.12 × 10\hat{ }(−3) |

Note:
Commercial NASICON was used to calibrate the measured conductivity results (Measured value: 0.75 mS cm⁻¹; Reported value (from the company): 1.2 mS cm⁻¹).

### REFERENCES

All references cited in this disclosure, including patents, patent applications, scientific papers and other publications, are hereby incorporated by reference into this application.
1. Hayashi, A., Hama, S., Morimoto, H., Tatsumisago, M. & Minami, T. Preparation of Li₂S—P₂S₅ amorphous solid electrolytes by mechanical milling. J. Am. Ceram. Soc. 84, 477-479 (2001).
2. Boulineau, S., Courty, M., Tarascon, J.-M. & Viallet, V. Mechanochemical synthesis of Li-argyrodite Li₆PS₅X (X=Cl, Br, I) as sulfur-based solid electrolytes for all solid state batteries application. Solid State Ion. 221, 1-5 (2012).
3. Kamaya, N. et al. A lithium superionic conductor. Nat. Mater. 10, 682-686 (2011).
4. Deiseroth, H.-J. et al. Li₆PS₅X: a class of crystalline Li-rich solids with an unusually high Li⁺ mobility. Angew. Chem. 120, 767-770 (2008).
5. Wang, C. & Li, W. Metal Phosphorothioates and Metal-Sulfur Electrochemical System Containing the Same, U.S. Patent 62/956,428.
6. Bischoff, C., Schuller, K., Haynes, M., & Martin, S. W. Structural investigations of yNa₂S+(1−y) PS_{5/2} glasses using Raman and infrared spectroscopies. J. Non-Cryst. Solids 358, 3216-3222 (2012).
7. Berbano, S. S., Seo, I., Bischoff, C. M., Schuller, K. E. & Martin, S. W. Formation and structure of Na₂S+P₂S₅ amorphous materials prepared by melt-quenching and mechanical milling. J. Non-Cryst. Solids 358, 93-98 (2012).
8. Wu, H. L., Huff, L. A. & Gewirth, A. A. In Situ Raman Spectroscopy of Sulfur Speciation in Lithium-Sulfur Batteries. ACS Appl. Mater. Interfaces 7, 1709-1719 (2015).
9. Hagen, M., et al. In-situ Raman investigation of polysulfide formation in Li—S cells. J. Electrochem. Soc. 160, A1205-A1214 (2013).
10. Janz, G. J. et al. Raman studies of sulfur-containing anions in inorganic polysulfide. Sodium polysulfide. Inorg. Chem. 15, 1759-1763 (1976).
11. Jaroudi, O. E., Picquenard, E., Demortier, A., Lelieur, J. P. & Corset, J. Polysulfide anions II: structure and vibrational spectra of S⁴⁻ and S⁵⁻ anions. Influence of the cations on bond length, valence, and torsion angle. Inorg. Chem. 39, 2593-2603 (2000).
12. Daly, F. P. & Brown, C. W. Raman spectra of sodium tetrasulfide in primary amines. Evidence for S⁴⁻ and S₈ⁿ⁻ in rhombic sulfur-amine solutions. J. Phys. Chem. 79, 350-354 (1975).
13. Jaroudi, O. E., Picquenard, E., Gobeltz, N., Demortier, A. & Corset, J. Raman spectroscopy study of the reaction between sodium sulfide or disulfide and sulfur: Identify of the species formed in solid and liquid phases. Inorg. Chem. 38, 2917-2923 (1999).
14. Pang, Q., Liang, X., Shyamsunder, A., & Nazar, L. F. An in vivo formed solid electrolyte surface layer enables stable plating of Li metal. Joule 1, 1-16 (2017).
15. Hibi, Y., Tanibata, N., Hayashi, A. & Tatsumisago, M. Preparation of sodium ion conducting Na₃PS₄—NaI glasses by a mechanochemical technique. Solid State Ion. 270, 6-9 (2015).
16. Miura, A. et al. Liquid-phase syntheses of sulfide electrolytes for all-solid-state lithium battery. Nat. Rev. Chem. 3, 189-198 (2019).

We claim:

1. A solid-phase or molten electrolyte comprising an mP₂S₅-nNa₂Sₓ complex, wherein the molar ratio of P₂S₅ to Na₂Sₓ (m:n) is between 1:2 and 2:1 and x is an integer from 1 to 12.

2. The solid-phase or molten electrolyte of claim 1, wherein the molar ratio of P₂S₅ to Na₂Sₓ (m:n) is 1:1.

3. The solid-phase or molten electrode of claim 1, wherein x is an integer from 6 to 8.

4. The solid-phase or molten electrode of claim 3, wherein x is 8.

5. A solid-state battery comprising a cathode, an anode, and a solid-state electrolyte in contact with the cathode and the anode, wherein the cathode and/or anode comprise:
an active material;
optionally a conductive additive; and
a solid-state qP₂S₅-rNa₂Sₓ complex, wherein:
the molar ratio of P₂S₅ to Na₂Sₓ (q:r) is between 1:2 and 2:1; and
x is an integer from 1 to 12;
and wherein the solid-state electrolyte comprises a solid-phase mP₂S₅-nNa₂Sₓ complex, wherein the molar ratio of P₂S₅ to Na₂Sₓ (m:n) is between 1:2 and 2:1 and wherein x is an integer from 1 to 12.

6. The solid-state battery of claim 5, wherein the molar ratio of P₂S₅ to Na₂Sₓ (q:r) is 1:1.

7. The solid-state battery of claim 5, wherein x of the solid-state qP₂S₅-rNa₂Sₓ complex is 8.

8. The solid-state battery of claim 5, wherein the cathode and/or anode further comprise a molten aP₂S₅-bNa₂S_{y} complex, wherein the molar ratio of P₂S₅ to Na₂S_{y} (a:b) is between 1:2 and 2:1; and y is an integer from 1 to 12.

9. The solid-state battery of claim 8, wherein the molar ratio of P₂S₅ to Na₂S_{y} (a:b) is 1:1.

10. The solid-state battery of claim 8, wherein y is 8.

11. The solid-state battery of claim 8, wherein the molar ratio of P₂S₅ to Na₂Sₓ (q:r) and the molar ratio of P₂S₅ to Na₂S_{y} (a:b) are the same and x and y are the same.

12. The solid-state battery of claim 11, wherein the molar ratio of P₂S₅ to Na₂Sₓ (q:r) and the molar ratio of P₂S₅ to Na₂S_{y} (a:b) are different or x and y are different.

13. The solid-state battery of claim 8, wherein the cathode and/or the anode comprise a continuous interphase.

14. A method of manufacturing a solid-phase electrolyte comprising an mP₂S₅-nNa₂Sₓ complex, wherein the method comprises:
mixing sodium sulfide (Na₂S), phosphorus pentasulfide (P₂S₅), and sulfur powder (S) in an organic solvent to form a solvated mP₂S₅-nNa₂Sₓ complex; and
exposing the solvated mP₂S₅-nNa₂Sₓ complex to less-than-atmospheric pressure to precipitate a solid-phase mP₂S₅-nNa₂Sₓ complex;
wherein the molar ratio of P₂S₅ to Na₂Sₓ (m:n) is between 1:2 and 2:1 and x is an integer from 1 to 12.

15. The method of claim 14, wherein organic solvent is selected from the group consisting of diethylene glycol dimethyl ether (diglyme), 1,2-dimethoxyethane, 1,3-dioxolane, tetrahydrofuran, tetraethylene glycol dimethyl ether, and methyl acetate.

16. The method of claim 14, wherein organic solvent is diglyme.

17. The method of claim 14, wherein the concentration of solvated mP₂S₅-nNa₂Sₓ complex in the organic solvent prior to precipitation is between about 0.5 M and about 2 M.

18. The method of claim 17, wherein the concentration of solvated mP₂S₅-nNa₂Sₓ complex in the organic solvent prior to precipitation is about 1.5 M.

19. A method of manufacturing a molten electrolyte comprising an mP₂S₅-nNa₂Sₓ complex, wherein the method comprises:
manufacturing a solid-phase electrolyte comprising an mP₂S₅-nNa₂Sₓ complex according to the method of claim 12; and
heating the solid-phase electrolyte to form the molten electrolyte;
wherein the molar ratio of P₂S₅ to Na₂Sₓ (m:n) is between 1:2 and 2:1 and x is an integer from 1 to 12.

20. The method of claim 19, wherein the solid-phase electrolyte is heated at a temperature of from about 50° C. to about 120° C.
